(19) United States
(12) Patent Application Publication
(10) Pub. No.: US 2022/0023898 A1
(43) Pub. Date: Jan. 27, 2022

(54) PUMP SYSTEM

(71) Applicant: J. WAGNER GmbH, Markdorf (DE)

(72) Inventors: SEBASTIAN MANGOLD, Salem (DE); MANUEL FIESEL, Friedrichshafen (DE); LEON LUCK, Markdorf (DE); BJÖRN FREISINGER, Krauchenwies (DE); TANJA MESSMER, Markdorf (DE)

(21) Appl. No.: 17/309,731

(22) PCT Filed: Dec. 19, 2019
(86) PCT No.: PCT/EP2019/086285

§ 371 Date: Jun. 16, 2021

(30) Foreign Application Priority Data
Dec. 21, 2018 (DE) 10 2018 133 406.0

(51) Int. Cl. B05B 9/04; F04B 43/12; B05B 9/08

(52) U.S. Cl. CPC B05B 9/0423; B05B 9/0872; F04B 43/1238

(57) ABSTRACT

A pump system for an atomizer nozzle system having at least two atomizer nozzles, in particular for an electrohydrodynamic atomizer as well as a method for operating an electrohydrodynamic atomizer, wherein the pump system comprises at least one hose assembly as well as at least one pump rotor (7) and at least one rolling body (6) for forming a rolling region of a peristaltic pump, wherein the hose assembly comprises at least the same number of hose channels as the number of atomizer nozzles, and in that each hose channel is assigned to an atomizer nozzle and connects it to the rolling region.

### CROSS-REFERENCES TO RELATED APPLICATIONS

This application is a Section 371 National Stage Application of International Application No. PCT/EP2019/086285, filed Dec. 19, 2019 and published as WO/2020/127715P1 on Jun. 25, 2020, and claims priority to German Application No. 102018133406.0, filed Dec. 21, 2018, the contents of both are hereby incorporated by reference in their entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

The electrohydrodynamic atomization of fluids is becoming increasingly significant in the field of coating methods. For example, PCT/EP2018/060117 discloses a device which uses electrohydrodynamic atomization to apply e.g. care products such as, for example, sun block to a person's body.

The prior art has likewise already disclosed customary peristaltic pumps, referred to as rolling pumps or hose pumps. In this context, a fluid is forced forward according to the principle of an expeller pump through mechanical deformation of a hose section and therefore delivered in a pumping fashion. Such pumps are also used in the abovementioned devices in order to feed a fluid to be atomized to the atomizer nozzles at which the fluid is then subjected to a high voltage in order to bring about electrohydrodynamic atomization.

However, during the electrohydrodynamic atomization of fluids, in particular of care products such as e.g. sun cream, the problem has arisen that individual nozzles can be become blocked and as a result an additional volume flow through the pump is applied to the further remaining open nozzles.

### BRIEF SUMMARY OF THE INVENTION

A pump system for an atomizer nozzle system having at least two atomizer nozzles, in particular for an electrohydrodynamic atomizer. A method for operating an electrohydrodynamic atomizer, wherein the pump system comprises at least one hose assembly as well as at least one pump rotor. and at least one rolling body for forming a rolling region of a peristaltic pump. The hose assembly comprises at least the same number of hose channels as the number of atomizer nozzles, and in that each hose channel is assigned to an atomizer nozzle and connects it to the rolling region.

### BRIEF DESCRIPTION OF THE SEVERAL VIEWS OF THE DRAWING(S)

FIG. 1 shows an exploded illustration of a peristaltic pump.

FIG. 2 shows a plan view of a peristaltic pump with a visible rolling region.

FIG. 3 shows a cross section through a hose assembly.

FIG. 4a shows a schematic illustration of an open jet from a nozzle opening.

FIG. 4b shows a schematic illustration of an open jet from a cylindrical atomizer nozzle.

FIG. 4c shows a schematic illustration of an open jet from a conical atomizer nozzle.

### DETAILED DESCRIPTION OF THE INVENTION

An object of an example of the invention is therefore to avoid, starting from a fluid tank for a plurality of nozzles, blockage of the nozzles in order to permit electrohydrodynamic atomization to the required quality.

This object is achieved by means of a pump system as claimed in patent claim 1. Advantageous developments and expedient refinements are disclosed in the dependent claims.

An example of the invention relates to a pump system for an atomizer nozzle system having at least two atomizer nozzles, in particular for an electrohydrodynamic atomizer, wherein the pump system comprises at least one hose assembly as well as at least one pump rotor and at least one rolling body for forming a rolling region of a peristaltic pump. The pump system is characterized in that the hose assembly comprises at least the same number of hose channels as the number of atomizer nozzles, preferably at least two, in particular three, hose channels, and in that each hose channel is assigned to an atomizer nozzle connector and connects it to the rolling region.

Supplying each individual atomizer nozzle with a separate hose channel gives rise to a volume flow through each individual atomizer nozzle so that if blockage begins to occur the delivered subsequent volume of fluid forcibly pushes out a blocking plug, thereby always ensuring a flow of fluid through the nozzle.

The use of a hose assembly with a plurality of hose channels provides the advantage here that common guidance of the hose assembly in the device can be easily provided without individual hoses having to be guided.

One preferred embodiment provides that each hose channel connects a fluid tank directly to an atomizer nozzle through the rolling region.

As a result of the formation of individual hose channels from the fluid tank up to the atomizer nozzles, each nozzle is directly supplied with fluid from the fluid tank without hydraulic communication/interaction, e.g. pressure equalization or a resulting volume flow between the channels, of the individual transportation paths being able to take place. As a result, a predefined volume flow is forcibly brought about at each individual atomizer nozzle, which gives rise to electrohydrodynamic atomization with process reliability.

Alternatively, one embodiment provides that a hose channel runs from a fluid tank to a point upstream of the rolling region, upstream of the rolling region there is formed a distribution into at least two, preferably three or more, hose channels, and these hose channels are arranged such that they run through the rolling region up to in each case one atomizer nozzle which is assigned to the respective hose channel.

The use of a single hose channel from the fluid tank to a point upstream of the rolling region facilitates, on the one hand, the connection to a valve system of the fluid tank and, on the other hand, provides a saving in terms of installation space and costs since less hose material has to be provided between the fluid tank and rolling region. Separate hose channels then have to be provided in the rolling region in which the delivery pressure for acting on the individual atomizer nozzles is generated, so that distribution, e.g. by means of Y elements or the like, occurs in advance.

One advantageous embodiment also provides that at least one atomizer nozzle is connected to at least two hose channels.

Through the use of a plurality of hose channels per atomizer nozzle, wherein each hose channel delivers in itself a defined fluid volume, a further increased process reliability and avoidance of faults can be achieved during the electrohydrodynamic atomization, since relatively small cross sections can be used and redundancies can be achieved. Through the use of relatively small hose diameters it is possible e.g. to implement tighter bending radii in the housing, which increases the flexibility with respect to design of the device architecture.

In a further expedient refinement at least two, preferably three, in particular four, rolling bodes are formed in the pump system, wherein each rolling body is individually assigned to at least one hose channel.

Through the use of individual rolling bodies or individual rolling body groups, wherein the rolling body groups comprise a plurality of rolling bodies, for one respective hose channel, an offset of the rolling movements between the hose channels can be brought about, in that the individual rolling body groups are arranged, e.g. with an angular offset, on the pump rotor, in order to generate a uniform fluid flow and in particular to reduce pulsation effects. It is also possible to adapt the rolling bodies to the hose channel geometry and/or to optimize the arrangement in the housing of the atomizer with respect to the installation space and the ergonomy.

A further expedient embodiment provides that at least two, preferably three, pump rotors are formed, wherein each pump rotor moves at least one rolling body or at least one rolling body group and is assigned to at least one hose channel.

The use of individual pump rotors which are driven by means of a common motor or else by means of separate motors or motor groups, permits improved control of the power of the pump system. Furthermore, it is also possible here to adapt the pump rotors to the hose channel geometry or the hose channel profile and/or to optimize the arrangement in the housing of the atomizer with respect to the installation space and the ergonomy.

An example of the invention also provides a method for operating an electrohydrodynamic atomizer, wherein the atomizer comprises at least one, in particular two, preferably three or more, atomizer nozzles, and a pump system according to an example of the invention as described above is included, and a defined volume flow of a fluid is forced onto each atomizer nozzle via the pump system.

The electrohydrodynamic atomization is based on the instability of electrically chargeable fluids, in particular fluids which are sufficiently electrically conductive under high voltage, in a strong nonhomogeneous electrical field. The fluid is subjected here to a high voltage. The fluid deforms here to form a cone, from the tip of which a thin jet is emitted, which jet then directly decomposes into a spray composed of finely dispersed droplets. Under certain conditions, in the Taylor cone mode, the droplets have a narrow size distribution. As a result of the interaction with forced hydraulic provision of a fluid flow it is possible to further improve an atomization effect.

An expedient development of the method is characterized in that a hydraulically generated open jet in the form of a fluid column is produced at the outlet of an atomizer nozzle and brings about atomization only after an open jet region as a result of electrohydrodynamic interaction.

As a result of the generated open jet, the electrohydrodynamic interactions can give rise to more degrees of freedom so that finer atomization is provided outside the previously geometrically defined nozzle channel.

In one preferred embodiment, when an opening in the atomizer nozzle has a diameter of 0.1 mm to 0.3 mm, preferably 0.2 mm, and/or a fluid channel in the atomizer nozzle has a length of 3 mm to 15 mm, preferably in the region of an insulator, an open jet of 10 mm to 15 mm is formed.

In this context, the fluid is supplied far upstream of the nozzle opening, and the atomization processes can form freely with respect to the surroundings, wherein the direction of the atomization is predefined by the general kinematics, in particular by the hydraulic outputting of the fluid flow.

A hose assembly according to an example of the invention is understood to be any collection of hoses which can be used in a peristaltic pump (rolling pump). It is irrelevant here whether the hose assembly is embodied as a jointly extruded multi-channel hose or as a combination of individual hoses.

A pump system according to an example of the invention comprises not only the actual pump assembly but also the necessary hoses, since in a peristaltic pump (rolling pump) the pumping volume is given by that hose section which is processed by the rolling bodies in order to move a fluid volume contained therein to upstream of the rolling body.

An example of the invention will now be explained in more detail with reference to the following exemplary embodiment. However, the subject matter of the invention is not limited to the illustrated embodiment.

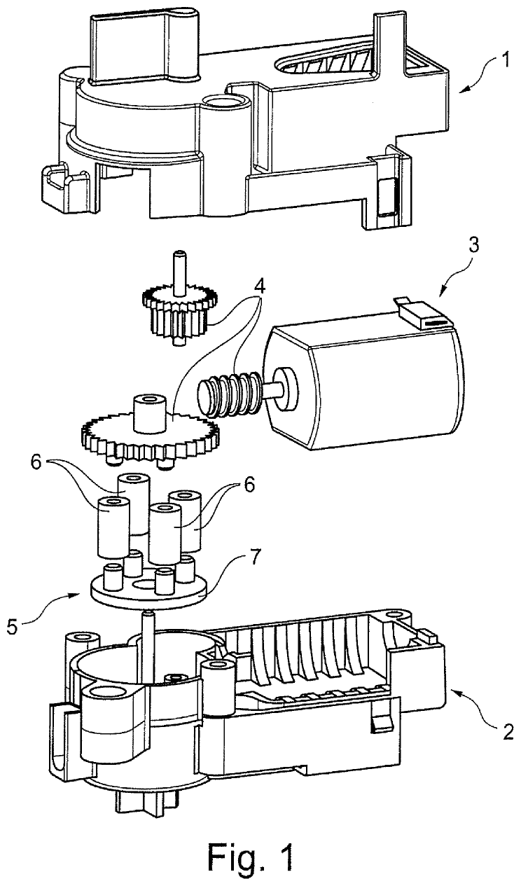

In particular, FIG. 1 shows the design of a known peristaltic pump. In this context, a motor 3 is arranged in a pump housing composed of an upper housing section 1 and a lower housing section 2. The output shaft of the motor 3 comprises a transmission arrangement 4 which drives a rolling body group 5 which is illustrated here. The rolling body group 5 comprises here four rolling bodies 6 which are arranged in a rotatably mountable fashion on a pump rotor 7. Such peristaltic pumps/hose pumps are known for use with individual hoses from the prior art.

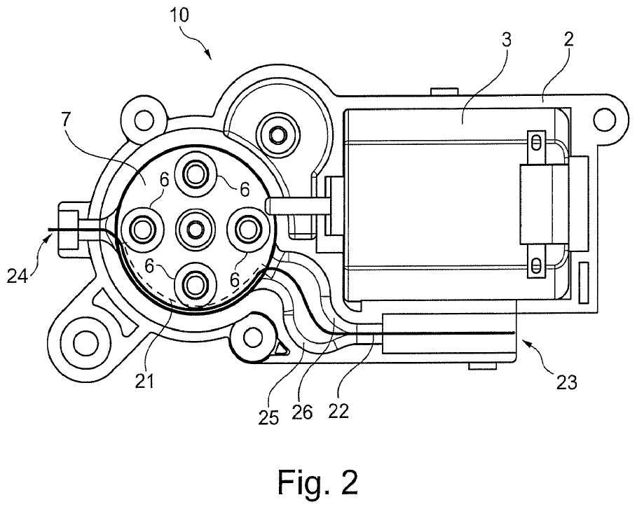

FIG. 2 illustrates a corresponding peristaltic pump 10 in a plan view, wherein the upper housing section 1 and the transmission arrangement 4 have been omitted.

The rolling bodies 6 which are arranged on the pump rotor 7 deform a hose channel 22 (illustrated schematically as a line) in a rolling region 21, in order to deliver a fluid in a pumping fashion. The hose channel 22 runs here through a pump inlet 23 into the housing 1, 2 through the rolling region 21 (illustrated by dashes) to a pump outlet 24. From the pump outlet 24, the hose channel 22 runs on in the direction of an atomizer nozzle (not illustrated) which is assigned thereto. At the pump inlet 23, the hose channel 22 leads in the direction of the fluid tank (not illustrated), wherein either an individual hose channel 22 extends as far as the fluid or a plurality of hose channels are combined to form a single fluid tank hose (not illustrated).

In order to guide a plurality of hose channels into the rolling region 21, hose guides 25 and 26 are preferably provided, wherein the hose guides 25 and 26 are arranged here in the lower housing section 2, and a hose guide (not illustrated) for the hose channel 22 can be arranged in the upper housing section 1.

The plurality of hose channels can then be guided out together at the pump outlet 24, or a corresponding plurality of hose guides (not illustrated) are formed for the individual hose channels.

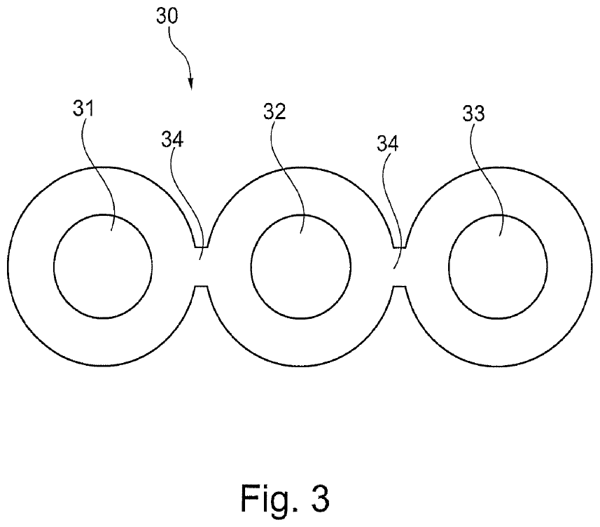

FIG. 3 shows a hose assembly 30 such as could be used in a pump system according to an example of the invention. The hose assembly 30 comprises here a first hose channel 31, a second hose channel 32 and a third hose channel 33 which are connected to one another here via connecting webs 34. Such hose assemblies 30 are manufactured, for example, using an extrusion method and can by all means also have further hose channels or be arranged in other geometries of hose channels, e.g. in a triangular shape or square shape.

Exemplary dimensions can be specified as follows, wherein the dimensions can be varied depending on the application and/or installation space and on the fluid to be transported.

By way of example, the hose channels 31, 32 and 33 have a diameter with a cross section of 0.7 mm and a wall thickness of 0.6 mm. The webs 34 in turn have a width as a distance between the hoses of 0.2 mm and a thickness of 0.2 mm too.

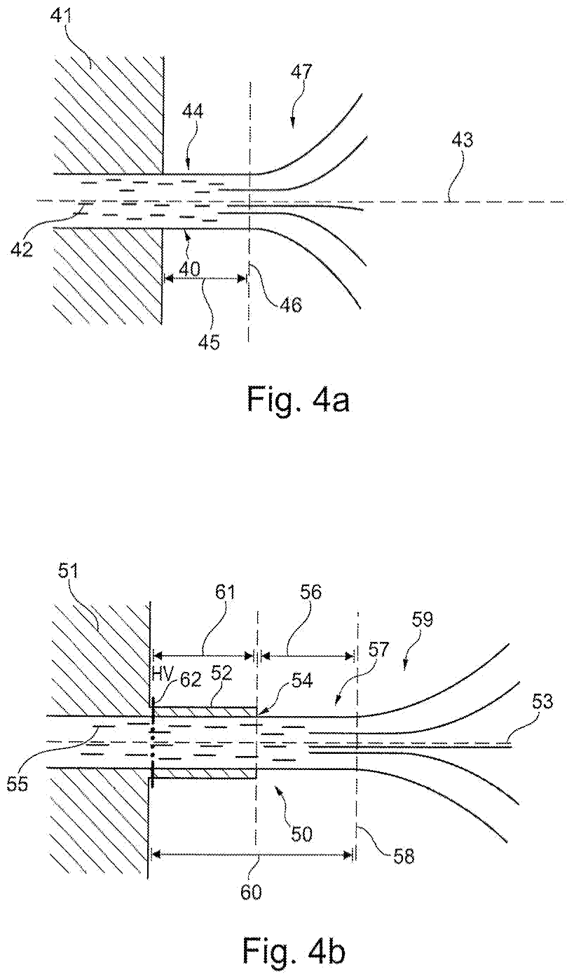

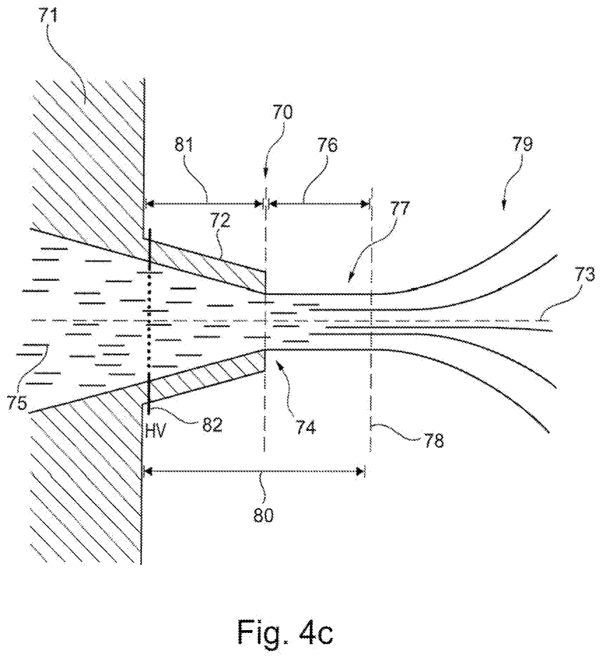

FIGS. 4a to 4c show different variants of the formation of a hydraulically generated open jet in front of an atomizer nozzle.

FIG. 4a shows a schematic illustration in which the atomizer nozzle is formed by a nozzle opening 40 in a nozzle body 41. A fluid 42 will emerge through the nozzle opening 40 symmetrically about a center axis 43 of the nozzle opening 40, as a column-shaped open jet 44, owing to the hydraulic pump pressure of the pump system according to an example of the invention. The open jet 44 emerges substantially as a fluid column over an open jet length 45, wherein the atomization effect 47 of the electrohydrodynamic atomizers begins only at a distance 46.

In FIG. 4b, a cylindrical nozzle attachment 52 is provided for forming an atomizer nozzle 50 on the nozzle body 51. At the end of the cylindrical nozzle attachment 52, a nozzle opening 54 which is formed symmetrically about a center axis 53 is provided. The hydraulically delivered fluid 55 flows through the nozzle body 51, the cylindrical nozzle attachment 52 and forms an open jet 57 over an open jet length 56. In this embodiment the atomization 59 also begins after the distance 58.

The atomizer nozzle therefore comprises a hydraulic section 60 which is composed of the length 61 of the cylindrical nozzle attachment 52 and the length of the open jet 56. In order to generate the electrohydrodynamic atomization, there is provision for a high voltage 62 to be coupled to the input of the cylindrical nozzle attachment 52. However, it is basically conceivable for the high voltage also to be introduced at another location in order to achieve the electrohydrodynamic atomization.

Preferred dimensions of an embodiment are here, as the diameter of the nozzle opening, 0.2 mm, and, as the fluid channel in the interior of the nozzle, 5.7 mm up to approximately 14 mm, wherein an open jet with an open jet length of 10 mm to 15 mm is generated as a result.

In a further embodiment according to FIG. 4c a conical nozzle attachment 72 for forming an atomizer nozzle 70 is provided on the nozzle body 71. At the end of the conical nozzle attachment 72 a nozzle opening 74 which is formed symmetrically about a center axis 73 is provided. The hydraulically delivered fluid 75 flows through the nozzle body 71, the cylindrical nozzle attachment 72 and forms an open jet 77 over an open jet length 76. In this embodiment the atomization 79 also begins after the distance 78.

The atomizer nozzle according to FIG. 4c likewise comprises a conical hydraulic section 80 which is composed of the length of the conical nozzle attachment 72 and the length of the open jet 76. In order to generate electrohydrodynamic atomization, there is provision for a high voltage 82 to be coupled to the input of the conical nozzle attachment 72. However, it is basically conceivable for the high voltage also to be introduced at another location in order to achieve the electrohydrodynamic atomization.

The invention is not restricted here to the exemplary embodiments illustrated. An example of the invention also claims the use according to the method for the operation of an electrohydrodynamic atomizer, in which the atomization effect is improved by the hydraulic generation of an open jet, in particular the atomization effect begins only after an open jet length 45, 56, 76 after the emergence from a nozzle opening.

Although the present invention has been described with reference to preferred embodiments, workers skilled in the art will recognize that changes may be made in form and detail without departing from the spirit and scope of the invention.

### LIST OF REFERENCE NUMBERS

1 Housing section
2 Housing section
3 Motor
4 Transmission arrangement
   4a Variant 1 of the formation of a hydraulically generated open jet in front of an atomizer nozzle.
   4b Variant 2 of the formation of a hydraulically generated open jet in front of an atomizer nozzle.
   4c Variant 3 of the formation of a hydraulically generated open jet in front of an atomizer nozzle.
5 Rolling body group
6 Rolling body
7 Pump rotor
10 Peristaltic pump
21 Rolling region
22 Hose channel
23 Pump inlet
24 Pump outlet
25 Hose guide
26 Hose guide
30 Hose assembly
31 Hose channel
32 Hose channel
33 Hose channel
34 Connecting webs
40 Nozzle opening
41 Nozzle body
42 Fluid
43 Center axis
44 Open jet
45 Open jet length
46 Distance
47 Atomization effect
51 Nozzle body
52 Nozzle attachment
53 Center axis
54 Nozzle opening
55 Fluid
56 Open jet length
57 Open jet
58 Distance
59 Atomization
60 Section
61 Nozzle attachment length
62 High voltage
70 Atomizer nozzle
71 Nozzle body
72 Nozzle attachment
73 Center axis
74 Nozzle opening
75 Fluid
76 Open jet length
77 Open jet
78 Distance
79 Atomization
80 Hydraulic section
81 Nozzle attachment length
82 High voltage

1. A pump system for an atomizer nozzle system having at least two atomizer nozzles, in particular for an electrohydrodynamic atomizer, wherein the pump system comprises at least one hose assembly as well as at least one pump rotor and at least one rolling body for forming a rolling region of a peristaltic pump, wherein
the hose assembly comprises at least the same number of hose channels as the number of atomizer nozzles, and in that each hose channel is assigned to an atomizer nozzle and connects it to the rolling region.

2. The pump system as claimed in claim 1, wherein each hose channel connects a fluid tank directly to an atomizer nozzle through the rolling region.

3. The pump system as claimed in claim 1, wherein a hose channel runs from a fluid tank to a point upstream of the rolling region, upstream of the rolling region there is formed a distribution into at least two, preferably three or more, hose channels, and these hose channels are arranged such that they run through the rolling region up to in each case one atomizer nozzle which is assigned to the respective hose channel.

4. The pump system as claimed in claim 1, wherein at least one atomizer nozzle is connected to at least two hose channels.

5. The pump system as claimed in claim 1, wherein at least two, preferably four, rolling bodies are formed, wherein each rolling body is assigned to at least one hose channel.

6. The pump system as claimed in claim 1, wherein at least two, preferably three, pump rotors (7) are formed, wherein each pump rotor moves at least one rolling body (6) and is assigned to at least one hose channel (22).

7. A method for operating an electrohydrodynamic atomizer, wherein the atomizer comprises at least one, preferably three or more, atomizer nozzles (70), wherein
a pump system as claimed in claim 1 is included, and a defined volume flow of a fluid (42, 75, 55) is forced onto each atomizer nozzle (70) via the pump system.

8. The method as claimed in claim 7, wherein a hydraulically generated open jet (44, 57, 77) in the form of a fluid column is produced at the outlet of an atomizer nozzle (70) and brings about atomization (79) only after an open jet region as a result of electrohydrodynamic interaction.

9. The method as claimed in claim 8, wherein when an opening in the atomizer nozzle (70) has a diameter of 0.1 mm to 0.3 mm and/or a fluid channel in the atomizer nozzle (70) has a length of 3 mm to 15 mm an open jet (44, 57, 77) of 10 mm to 15 mm is formed.
